(19) United States
(12) Patent Application Publication
(10) Pub. No.: US 2026/0352905 A1
(43) Pub. Date: Nov. 5, 2026

(54) CONTROLLING THE SENDING OF AT LEAST ONE PICTURE OVER A COMMUNICATION NETWORK

(71) Applicant: Telefonaktiebolaget LM Ericsson (publ), Stockholm (SE)

(72) Inventors: Oskar DRUGGE, Hjärup (SE); Ying SUN, Täby (SE); Martin PETTERSSON, Vallentuna (SE); Balázs Peter GERÖ, Budapest (HU)

(73) Assignee: Telefonaktiebolaget LM Ericsson (publ), Stockholm (SE)

(21) Appl. No.: 19/125,435

(22) PCT Filed: Oct. 31, 2022
(86) PCT No.: PCT/EP2022/080362

§ 371 Date: Apr. 29, 2025

(51) Int. Cl. H04N 21/24; H04N 21/2343; H04N 21/845

(52) U.S. Cl. CPC H04N 21/2402; H04N 21/2343; H04N 21/8456

(57) ABSTRACT

It is provided a method for controlling the sending of at least one picture, the method being performed by a video sender connected to a communication network. The method comprises: receiving an adaptation message from a network condition evaluator of the communication network, wherein the adaptation message is based on network conditions on a path of the communication network between the video sender and a video receiver; adapting the number of segments of at least one future picture; and sending the segments of the at least one future picture to the video receiver. Embodiments for the network condition evaluator side are also provided.

### TECHNICAL FIELD

The present disclosure relates to the field of video transfer, and in particular to controlling the sending of at least one picture over a communication network.

### BACKGROUND

Digital video is increasing in popularity, from broadcast services, to streaming services and individual video streaming. New services employing high data rates with associated requirements for low latency are expected to be served by mobile networks in the coming years. In particular services such as cloud assisted augmented reality (AR) and remote driving, are services that may require high rates in combination with requirements for low lag in the end-user service which drives the requirement to deliver e.g. a video frame or other rich sensor data within a stipulated delay budget.

There is a greater challenge to deliver a large amount of data for video in a wide area communication network (e.g. comprising a cellular network), compared to dedicated local networks. For instance, users of wide area networks may be located indoors, communicating with a macro tower outdoors such that the signal needs to be transmitted with a transmitter that has limited output power but still needs to get through walls/windows and reach a receiver that could be several hundred meters away.

Before video is transmitted over a communication network, it is compressed into a video bitstream using a video codec. The bitstream is then decompressed on the receiving side before further processing and/or display. Examples of widely deployed video codecs include H.264/AVC (advanced video coding), H.265/HEVC (high-efficiency video coding) and H.266/VVC (versatile video coding), all developed and standardized jointly by MPEG (moving picture experts group) and ITU-T (international telecommunications union—Telecommunications sector). Other codecs with some market deployment include VP8, VP9 and AV1.

When network conditions deteriorate, the standard way to adapt is to reduce the bitrate of the encoded video data transferred over the communication network. While this is certainly effective, the reduced bitrate also significantly decreases the quality (e.g. resolution or other encoding quality parameters) of the video data.

### SUMMARY

One object is to provide a way to adapt video data transfer based on network conditions while keeping the same bitrate.

According to a first aspect, it is provided a method for controlling the sending of at least one picture, the method being performed by a video sender connected to a communication network. The method comprises: receiving an adaptation message from a network condition evaluator of the communication network, wherein the adaptation message is based on network conditions on a path of the communication network between the video sender and a video receiver; adapting the number of segments of at least one future picture; and sending the segments of the at least one future picture to the video receiver.

The adaptation message may comprise an indication of a maximum segment size, in which case the adapting the number of segments is performed under the condition of complying with the indication of the maximum segment size.

The adaptation message may comprise a recommended number of segments per picture, in which case the adapting the number of segments comprises adapting the number of segments to the recommended number of segments per picture.

The adaptation message may comprise a recommendation for reducing the number of segments per picture or a recommendation for increasing the number of segments per picture.

The video sender may comprise a video encoder, in which case the adapting the number of segments of the one or more pictures, is performed by the video encoder.

The sending may comprise sending each one of the segments individually.

Each one of the segments may be at least one of a slice, tile, subpicture, decoding unit, gradual decoding refresh area, and video coding layer network abstraction layer unit.

The adapting the number of segments may be performed based on the adaptation message.

The adapting the number of segments may be performed such that improved network conditions result in fewer segments per picture and deteriorated network conditions result in more segments per picture.

According to a second aspect, it is provided a video sender for controlling the sending of at least one picture, the video sender being configured to be connected to a communication network. The video sender comprises: a processor; and a memory storing instructions that, when executed by the processor, cause the video sender to: receive an adaptation message from a network condition evaluator of the communication network, wherein the adaptation message is based on network conditions on a path of the communication network between the video sender and a video receiver; adapt the number of segments of at least one future picture; and send the segments of the at least one future picture to the video receiver.

The adaptation message may comprise an indication of a maximum segment size, in which case the instructions to adapt the number of segments comprise instructions that, when executed by the processor, cause the video sender to adapt under the condition of complying with the indication of the maximum segment size.

The adaptation message may comprise a recommended number of segments per picture, in which case the instructions to adapt the number of segments comprise instructions that, when executed by the processor, cause the video sender to adapt the number of segments to the recommended number of segments per picture.

The adaptation message may comprise a recommendation for reducing the number of segments per picture or a recommendation for increasing the number of segments per picture.

The video sender may comprise a video encoder, in which case the instructions to adapt the number of segments of the one or more pictures, is performed by the video encoder.

The instructions to send may comprise instructions that, when executed by the processor, cause the video sender to send each one of the segments individually.

Each one of the segments may be at least one of a slice, tile, subpicture, decoding unit, gradual decoding refresh area, and video coding layer network abstraction layer unit.

The instructions to adapt the number of segments may comprise instructions that, when executed by the processor, cause the video sender to adapt the number of segments based on the adaptation message.

The instructions to adapt the number of segments may comprise instructions that, when executed by the processor, cause the video sender to adapt the number of segments such that improved network conditions result in fewer segments per picture and deteriorated network conditions result in more segments per picture.

According to a third aspect, it is provided a computer program for controlling the sending of at least one picture. The computer program comprises computer program code which, when executed on a video sender causes the video sender to: receive an adaptation message from a network condition evaluator of the communication network, wherein the adaptation message is based on network conditions on a path of the communication network between the video sender and a video receiver; adapt the number of segments of at least one future picture; and send the segments of the at least one future picture to the video receiver.

According to a fourth aspect, it is provided a computer program product comprising a computer program according to the third aspect and a computer readable means comprising non-transitory memory in which the computer program is stored.

According to a fifth aspect, it is provided a method for controlling the sending of at least one picture, the method being performed in a network condition evaluator connected to a communication network. The method comprises: evaluating network conditions of at least part of a path of the communication network between a video sender and a video receiver; generating an adaptation message based on the network conditions, wherein the adaptation message comprises an indication for the video sender to adapt the number of segments in at least one future picture; and sending the adaptation message to the video sender.

The generating an adaptation message may comprise determining a recommended number of segments per picture to be sent by the video sender, in which case the adaptation message comprises the recommended number of segments per picture.

The generating an adaptation message may comprise reducing the recommended number of segments per picture when network conditions have improved and increasing the recommended number of segments per picture when network conditions have deteriorated.

The generating an adaptation message may comprise determining the recommended number of segments based on a proportion of congestion marked packets.

A congestion marked packet may be detected using an Explicit Congestion Notification of a header of an internet protocol packet evaluated by the network condition evaluator.

The adaptation message may comprise a proportion of congestion marked packets of all packets detected between the video sender and the video receiver.

The generating an adaptation message may comprise determining a minimum segment size that can be reliably delivered within a set packet delay budget.

The determining a minimum segment size may be made based on at least one of: time-division duplex pattern, signal strength measurements, interference measurements, power headroom measurements, and queue time.

The generating an adaptation message may comprise determining a maximum segment size for segments of pictures to be sent by the video sender, in which case the adaptation message comprises an indication of the maximum segment size.

The adaptation message may comprise a recommendation for reducing the number of segments per picture.

The adaptation message may comprise a recommendation for increasing the number of segments per picture.

The evaluating network conditions may be based on metrics of the communication network for at least one of: queue build-up, channel conditions, interference situation, load conditions, power headroom indications, numerology, and Time Division Duplex pattern.

The network condition evaluator may be a radio base station, a router or a gateway.

The network condition evaluator may be the video receiver.

According to a sixth aspect, it is provided a network condition evaluator for controlling the sending of at least one picture, the network condition evaluator being configured to be connected to a communication network. The network condition evaluator comprises: a processor; and a memory storing instructions that, when executed by the processor, cause the network condition evaluator to: evaluate network conditions of at least part of a path of the communication network between a video sender and a video receiver; generate an adaptation message based on the network conditions, wherein the adaptation message comprises an indication for the video sender to adapt the number of segments in at least one future picture; and send the adaptation message to the video sender.

The network condition evaluator may be a radio base station, a router or a gateway.

The network condition evaluator may be the video receiver.

According to a seventh aspect, it is provided a computer program for controlling the sending of at least one picture. The computer program comprises computer program code which, when executed on a network condition evaluator being configured to be connected to a communication network, causes the network condition evaluator to: evaluate network conditions of at least part of a path of the communication network between a video sender and a video receiver; generate an adaptation message based on the network conditions, wherein the adaptation message comprises an indication for the video sender to adapt the number of segments in at least one future picture; and send the adaptation message to the video sender.

According to an eighth aspect, it is provided a computer program product comprising a computer program according to the seventh aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied.

FIGS. 2A-B are schematic diagrams illustrating various ways of segmenting a picture;

FIGS. 3A-B are schematic diagrams illustrating embodiments of where the network condition evaluator can be implemented;

FIG. 4 is a is swimlane diagram illustrating embodiments of methods for controlling the sending of at least one picture;

FIG. 5 is a schematic diagram illustrating components of the video sender and/or the network condition evaluator of FIG. 1;

FIG. 6 is a schematic diagram showing functional modules of the video sender of FIG. 1 according to one embodiment;

FIG. 7 is a schematic diagram showing functional modules of the network condition evaluator of FIG. 3A or 3B according to one embodiment; and

FIG. 8 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

Embodiments presented herein exploit that video pictures are often split into segments of different types, and adjusting the number of segments per picture based on network conditions. In this way, the bitrate of the video is unaffected (except for some potential slight segmentation overhead) while still addressing issues caused by deteriorating network conditions.

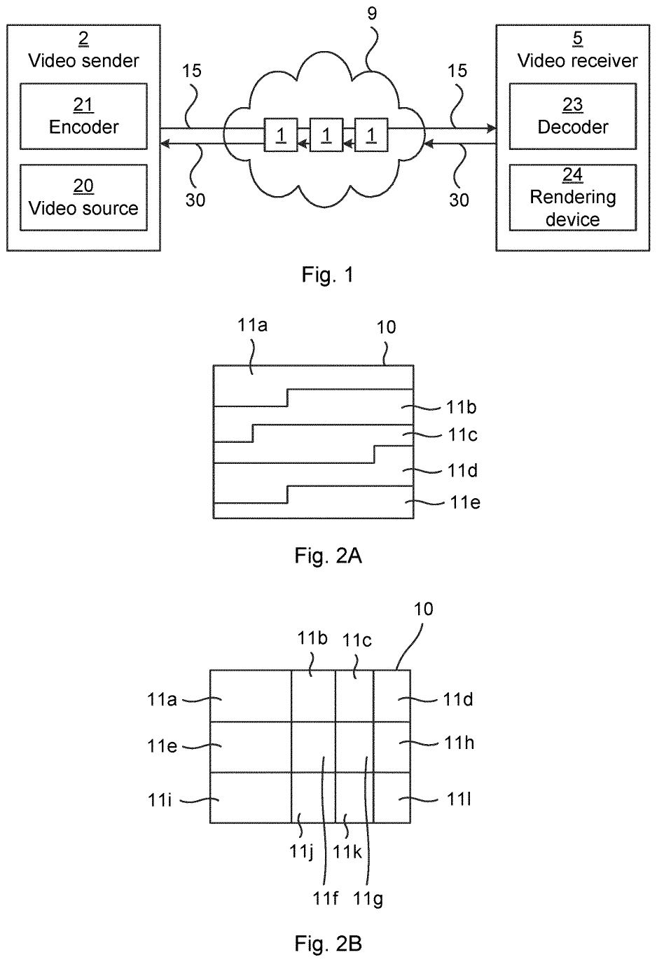

FIG. 1 is a schematic diagram illustrating an environment in which embodiments presented herein can be applied.

A video sender 2 is an electronic device that is capable of capturing, encoding and sending a bitstream for video data. The video sender 2 can e.g. be implemented using any one or more of a smartphone, a wearable device (such as a head mounted display, HMD), a tablet computer, a laptop computer, a desktop computer or a server. The video sender 2 comprises a video source 20 and an encoder 21. The video source 20 can e.g. be a camera that captures a video stream from its environment. The video stream is made up of a sequence of pictures (also known as frames, used interchangeably herein). The encoder 21 is configurable in terms of segment size and/or the number of segments per picture. The video sender 2 may also comprise a packetizer that is able to packetize the bitstream into segments.

The encoder 21 takes the video stream as input and encodes each picture of the video stream into a coded video bitstream. As explained in more detail below, each picture can be split into segments in various ways. The video sender 2 sends the segments of the pictures in encoded video data 15 to a video receiver 5 via a communication network 9.

The communication network 9 can comprise a wide area network 6, such as the Internet, and optionally includes communication via Wi-Fi or a cellular network. The communication network 9 can support Internet Protocol (IP) traffic. The cellular communication network can e.g. comply with any one or a combination of sixth generation (6G) mobile networks, fifth generation, (5G) mobile networks, LTE (Long Term Evolution), UMTS (Universal Mobile Telecommunications System) utilising W-CDMA (Wideband Code Division Multiplex), or any other current or future wireless network, as long as the principles described hereinafter are applicable.

The communication network 9 can comprise any number of intermediary network nodes 1 on a path through the communication network 9 between the video sender 2 and the video receiver 5. Each one of the network nodes 1 can e.g. be a radio base station (of a cellular network), a router or a gateway.

The video receiver 5 receives the encoded video data 15, decodes the encoded video data 15 in a decoder 23 and outputs the decoded video for further processing, e.g. for machine analysis and/or presents the decoded video to a human using a rendering device 24. The video receiver 5 can be implemented in hardware and/or software on an end-user device, such as a mobile phone, a computer, a head mounted display (HMD). The video receiver 5 comprises a video decoder that decodes the video bitstream and may comprise a display to display the decoded video. Alternatively, the video receiver 5 may be located in another node in the network providing a cloud service, e.g., it may be in an edge cloud, or a centrally located server. The video receiver 5 then decodes the segments of the video, process the video, possibly before encoding it again and sending it to an end-user device for display.

It is to be noted that, in parallel, audio can be captured, encoded, transferred, decoded and presented in synchronicity with the video, but this process is omitted here since embodiments presented herein are mainly concerned with video.

Network conditions of at least part of the communication network 9 can be evaluated at either one or both of the network nodes 1 and the video receiver 5. Based on the network conditions, the network nodes 1 and/or the video receiver 5 sends an adaptation message 30 to the video sender 2, causing the video sender to adapt the number of segments per picture.

One way to detect and signal network conditions is L4S (Low Latency Low Loss Scalable throughput) in a RAN (Radio Access Network). Any node serving an L4S capable data flow may set the Explicit Congestion Notification (ECN) bits in the IP header for the flow if congestion is experienced. The receiving node (e.g. the video receiver 5) collects the congestion/ECN statistics and feedbacks this to the corresponding sending node (e.g. the video sender 2). Common protocols for real time streaming are the Real Time Transport Protocol (RTP) used together with RTCP (Real Time Control Protocol) to convey feedback information. Based on the reported congestion information, sending node application adapts its data rate to maintain low queue delays and short end-to-end latency. Thus, congestion indications are set in the forward direction, collected by the receiving node and sent in a feedback protocol to the sending node.

Packets are marked as congested when queue delays are very low which gives a prompt reaction to small signs of congestion, allowing the end hosts to implement scalable congestion control where the transmission rate (or congestion window) is changed in proportion to the fraction of congestion-marked packets.

L4S enables real-time critical data applications to adapt their rate to the weakest link, providing reduced latency impact due to queue build up. L4S is often triggered by thresholds in the input queue of a network node and may be used to signal a congested situation. Given that most network nodes have a fairly stable or slowly varying output rate, this provides good results. For radio networks, the output rate variations over the wireless link may be more frequent than in traditional wired solutions, which leads to sudden latency peaks even when L4S is used. Nevertheless, there could be more or less advanced schemes to derive the L4S marking. For instance, an expected queue can be determined using predictive methods, which may be able to flag congestion even before it has occurred.

Another concept that can be used is access network bitrate recommendation. According to 3GPP (third generation partnership project) TS (technical specification) 24.114, the access network can recommend access network bitrate recommendations (ANBR) to MTSI (Multimedia Telephony Service for IP multimedia system) clients in a terminal. Some access networks may provide the MTSI client in terminal with ANBR messages, separately per local access bearer and separately for the local uplink and downlink. It is expected that an ANBR message is sent to the MTSI client in terminal whenever the access network finds it reasonable to inform about a change in the recommended bitrate, such that the MTSI client in terminal is generally provided with up-to-date recommended bitrate information.

A single access bearer can carry multiple RTP streams, in which case ANBR applies to the sum of the individual RTP stream bitrates on that bearer.

Access networks supporting ANBR may also support a corresponding ANBR Query (ANBRQ) message, which allows the MTSI client in terminal to query the network for updated ANBR information. ANBRQ shall only be used to query for an ANBR update when media bitrate is to be increased, not for media bitrate decrease.

The recommended bitrate procedure is used to provide the MAC (Medium Access Control) entity with information about the bitrate recommended by the radio base station. The recommended bitrate indicates the bitrate that the radio condition can support at the physical layer. An averaging window of default value 2000 ms will apply as specified in 3GPP TS 26.114.

An MTSI client in a terminal shall use the ANBR message as application adaptation trigger, taking other available triggers into account. The same principle shall apply for both speech and video, adapting to the lowest bitrate resulting from any of the possibly multiple, available triggers.

FIGS. 2A-B are schematic diagrams illustrating various ways of segmenting a picture 10. A video codec often supports both intra-coded and inter-coded pictures. An intra-coded picture may only predict from samples of the same picture, whereas inter-coded pictures may also predict from previously decoded pictures, referred to as reference pictures. Inter-coded pictures may be divided into P-pictures, which may only predict from one reference picture at a time for each coding block and bidirectional B-pictures, which may predict from up to two reference pictures simultaneously for each coding block.

In order to tune into a bitstream or recover from lost or corrupted frames, the video bitstream often includes periodic intra-coded pictures, often referred to as a key frames in video coding. In AVC, HEVC and VVC such pictures are called intra random access point (IRAP) pictures. AVC, HEVC and VVC also supports tuning into the bitstream at an inter-coded picture using gradual decoding refresh (GDR), where each picture from the tune-in point often refreshes a new part of the picture, by coding that area with intra-coded blocks, referred to here as GDR clean area, until the whole picture has been refreshed. Areas that have not yet been refreshed are referred to as dirty areas. GDR is normatively supported in VVC using the GDR picture type, and optionally supported in AVC and HEVC using the recovery point supplemental enhancement information (SEI) message. The pictures in the video bitstream from an IRAP/GDR picture to the next IRAP/GDR picture is referred to as a coded video sequence.

Block-based video codecs such as AVC, HEVC and VVC often divides the picture into largest coding units (LCUs) which may be further subdivided into smaller coding units (CUs) before applying prediction and transform coding. The largest coding unit in AVC is called macro block (MB) and comprises 16×16 pixels and in HEVC and VVC it is called coding tree unit (CTU) and can comprise up to 128×128 pixels. Many video codecs, including AVC, HEVC and VVC support partitioning of a picture into independently coded segments.

In FIG. 2A, a picture 10 is shown split into a number of segments 11a-e in the form of picture slices. AVC, HEVC and VVC support segmentation of s picture in raster scan slices, where a picture is divided into slices based on the raster scan order of the MBs for AVC, the CTUs for HEVC and tiles (see below) for VVC. Each slice includes a slice header and the slices are packed into video coding layer (VCL) network abstraction layer (NAL) units. There are also non-VCL NAL units in the bitstream comprising parameter sets per sequence and picture level, SEI messages, etc, with coding information more accessible to the systems layer.

Raster scan slices are useful for dividing a picture into segments of somewhat similar number of bits. This is for instance useful when the bit size of the picture is larger than the maximum transmission unit (MTU). For ethernet, the standard MTU size is 1500 bytes. Slices may also be useful for error robustness reasons. It is often easier to perform error concealment on a lost slice than on a lost picture. AV1 also uses a concept similar to slices, where each part of the picture is referred to as a segment.

In FIG. 2B, a picture 10 is shown split into a number of segments 11a-l in the form of tiles. HEVC and VVC supports tile segmentation, where a picture is divided into an M×N grid of tiles, where each tile includes one or more whole CTUs. A slice may contain multiple tiles or a tile may be divided into one or more slices, for HEVC raster scan slices and for VVC something called rectangular slices. In contrast to slices, tiles do not have a header. FIG. 2B below shows an example of a picture 10 divided into twelve tiles. Dividing a picture into equally spatially sized segments, which may be easily done with tiles, is useful for parallel processing in the encoding and/or decoding of the video.

VVC also supports a concept called subpictures. A subpicture contains one or more slices that collectively cover a rectangular region of a picture. The subpicture partitioning is specified on a sequence level, i.e., it is valid for all pictures from one IRAP picture to another, whereas the slice partitioning and tile partitioning may be changed for each picture. The subpicture layout may not change between pictures in a sequence and does not have any temporal dependencies with the other subpictures in a picture making it possible to extract subpicture streams from a video bitstream and even merge subpicture streams with subpicture streams from another video bitstream. This is in particular useful in certain XR (extended reality) scenarios, e.g., for 360 degree video, where subpictures of high quality only need to be sent for the specific area the user is currently watching in a head mounted display (HMD). The other subpictures may be of a lower quality.

Unless explicitly stated otherwise, we herein use the term segment to describe any type of picture partitioning including, but not limited to, slices, tiles, subpictures, GDR area, VCL NAL unit and segments as used in AV1.

Dividing a picture into independently decodable segments may be beneficial in various ways as described above. However, on the downside, dividing a picture into independently decoded segments, the required bitrate to achieve the same quality increases, partly due to bitrate overhead from the additional segment headers, but also due to worse prediction as there are less samples to predict from. This effect becomes worse the smaller the segments are, and especially when there is fast-moving content.

For an AR uplink transmission being sent from an indoor user, it can help to increase the data bandwidth used for the link up to a point where the data bandwidth is close to or above the information rate targeted (to the point where the link enters the power limited region). An example of a reasonable target rate for AR could be 6-20 Mbits/s. Once enough data bandwidth has been allocated, the throughput can be increased by increasing the output power so as to improve the received SINR (signal to interference and noise ratio), but this can only be done up to the point where the transmitter is transmitting at its maximum output power. Beyond this point, to support a higher rate, with withheld latency performance, the SINR can be marginally improved by means such as using larger antenna arrays with more directivity, reducing interference by interference coordination schemes, reducing the noise figure of the receiver. Ultimately though, the most powerful tool to increase the rate would be by reducing the distance between the transmitter and receiver, i.e. densifying the communication network. Densifying the network is a very costly step to take for a mobile network operator, so should be avoided if possible. Further methods, as presented in embodiments presented herein, to increase end-user experience that would alleviate the need for densification are important.

For a bursty, time critical, service, the required rate of transmission may differ significantly from the required rate of transmission for a service with (at least piecewise) continuously streaming data with no or very relaxed latency requirements.

Consider an example where an XR frame arrives at a certain point in time. Frames may be generated with an interarrival time corresponding to the frame rate of the application and the interarrival time can be larger than the required delay budget.

For uplink communication in a wireless system (e.g. 5G), the delay budget will need to cover the following parts for efficient communication:

Data indication delay: The delay from when data arrives in the buffer at gNB/UE (user equipment) side until the scheduler is made aware of it.

Queuing delay: The delay that may occur because the scheduler is prioritizing other users/services even though it is aware of the data in the buffer.

Transmission delay: The delay to transfer the data burst, which may need to be serialized into multiple sections, each transmitted in one radio slot. Depending on the scheduler approach there may be queuing delay for each individual section/slot (e.g. round robin scheduling).

Margin for retransmission of last packets: The delay towards the end, where even though all segments have had their first transmission, there may still be some that failed and are in the process of being retransmitted using HARQ (hybrid automatic repeat request).

Due to the limitations in required bitrate, the size of the frame being sent, i.e. the minimum volume of data that needs to be transmitted within the latency budget will be greatly affecting the coverage for an XR service operating over a wireless network.

The frame size of a service is tightly connected to the operation of the respective service at the application level. As an example, an AR service may perform multiple functions that are all needed for the service, e.g. object detection, object tracking, mapping, localization and more. Each of these functions may be performed either internally, in a head mounted display (HMD), or with part of the processing being done in an edge computing cloud server. Considering the case of processing being done in the edge cloud, the sensors located in the AR HMD would collect data (e.g. video frames, depth sensor frames) and send the sensor input to the edge cloud for further processing. The edge cloud processing can now be done in different ways, assuming that more or less of the full snapshot of sensor data is processed in one go. As an example, consider the process of object detection, a picture of the full view would be collected at time to at the HMD. This picture could according to a first alternative be transmitted in full across the mobile network to an edge cloud and the processing of object detection using the picture could start once the full picture is available.

As a second alternative the picture could instead be partitioned into multiple segments, where each of the segments would be sent sequentially to the edge cloud, and the processing of object detection could be done using a segment-by-segment approach. The second alternative may have drawbacks, as the processing would have less information to work with. Consider as an example object detection done sequentially with multiple segments of a picture, when working with a segment of a picture the algorithm may fail to identify an object that happened to lie just on the border between two segments. On the other hand, the segment-by-segment processing could greatly reduce the size of picture frame that the mobile network would need to deliver within a stipulated delay budget, thereby greatly increasing the coverage given a fixed network deployment.

According to embodiments presented herein, it is provided a solution which dynamically adapts the segmenting of video pictures depending on the radio environment.

Assessments on e.g. queue build-up, channel conditions, interference situation, load conditions, capability of the used numerology, TDD (time-division duplex) pattern and feature set could be done by a network node within the RAN. Based on these assessments, the network node would signal to the source encoder (video sender) that it needs a more granular (more segments per picture) representation of the source sensor data (e.g. picture), as the current granularity of representation cannot be supported given the current deployment, configuration and conditions.

Signalling could either be through an API (application programming interface) exposed at application layer or using signalling similar or identical to L4S described above, that involves toggling of a bit in a communication frame header with increasing or decreasing frequency to indicate the need for a less or more granular source sensor representation.

Signalling could be either differential in the sense that it could represent code-words for increasing granularity (more segments per picture) of video encoding or decreasing granularity (fewer segments per picture) of video encoding. Signalling from application to network about the minimum segment size or maximum frequency of the segment to assist state switching decision in network between to adapt segment size and frequency with the same target data rate or to adapt application data rate. When minimum segment size or maximum frequency of segments is not reached, the access network could toggle increasing the frequency of the segments; but when minimum segment size or maximum frequency of segments are reached, and there is queued data in the buffer, the network could trigger the recommendation and send signal to application to reduce application data rate via L4S ECN toggling or ANBRQ signal.

As the video sender reduces the burst-sizes, the reach for the communication service is increased, with only limited reduction in end-to-end experience.

Embodiments presented herein include a system in which network conditions are evaluated, e.g. based on queue build-up, channel conditions, interference situation, load conditions, optionally combined with RAN internal information on configuration such as used numerology, TDD pattern and feature set. This evaluation is used to affect the number of segments per picture at the video sender.

The embodiments presented herein comprise signalling information from the network condition evaluator 3 to the video sender 2.

The video sender 2 uses this recommendation to increase, decrease or set the granularity in which the video sender 2 breaks the representation of one snapshot of sensor data (e.g. a picture) into smaller, individually consumable data units (segments).

For example, as a response to the received signalling, the video sender 2 increases or decreases the number of segments used to encode a video frame and the corresponding video stream parser and decoder in the video receiver 5 starts decoding the received slice as soon as the slice arrives.

The change of processing granularity may trigger further configuration changes in other components of the application pipeline, e.g. in a SLAM (simultaneous localisation and mapping) or in object detection components.

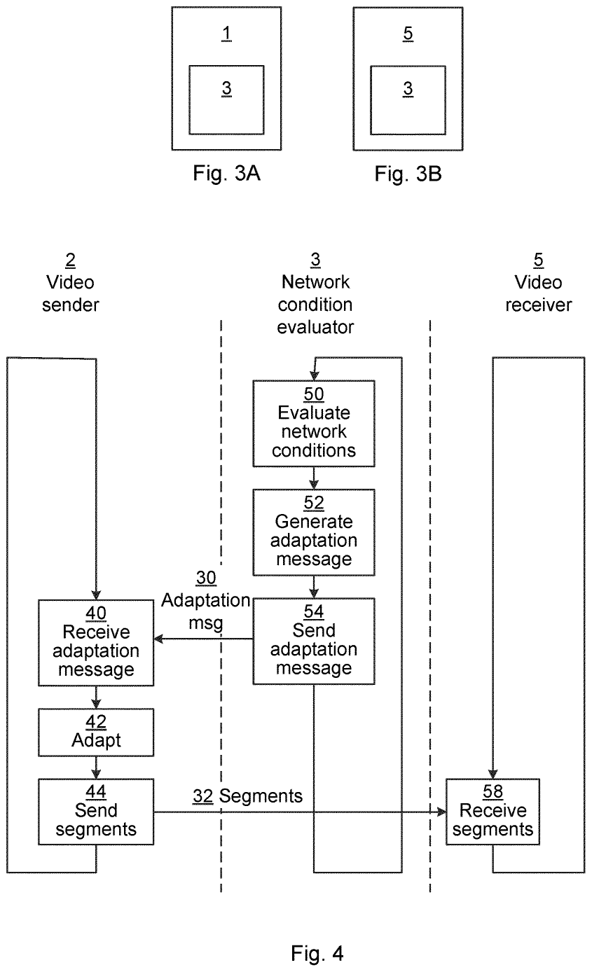

FIGS. 3A-B are schematic diagrams illustrating embodiments of where the network condition evaluator 3 can be implemented.

In FIG. 3A, the network condition evaluator 3 shown as implemented in the network node 1. The network node 1 is thus the host device for the network condition evaluator 3 in this implementation.

In FIG. 3B, the network condition evaluator 3 shown as implemented in the video receiver 5. The video receiver 5 is thus the host device for the network condition evaluator 3 in this implementation.

FIG. 4 is a is swimlane diagram illustrating embodiments of methods for controlling the sending of at least one picture. The swimlane diagram can be considered to comprise a flow chart for methods in the video sender 2 in the left swimlane, and a flow chart for methods in the network condition evaluator 3 in the centre swimlane. Communication between the video sender 2, the network condition evaluator 3 and the video receiver 5 is also shown. The video sender 2, network condition evaluator 3, and video receiver 5 communicate via a communication network 9, such as the communication network 9 of FIG. 1. As explained above, the network condition evaluator 3 can be a node separate from the video receiver 5. For instance, the network condition evaluator 3 can be a network node, e.g. a radio base station, a router or a gateway. Alternatively, the network condition evaluator 3 is the video receiver 5, i.e. the network condition evaluator 3 is implemented within the video receiver 5.

In an evaluate network conditions step 50, the network condition evaluator 3 evaluates network conditions of at least part of a path of the communication network 9 between a video sender 2 and a video receiver 5.

The evaluating of network conditions can be based on metrics of the communication network 9 for at least one of: queue build-up, channel conditions, interference situation, load conditions, power headroom indications, numerology, and TDD pattern.

In a generate adaptation message step 52, the network condition evaluator 3 generates an adaptation message based on the network conditions. The adaptation message comprises an indication for the video sender 2 to adapt the number of segments in at least one future picture.

Optionally, the generating the adaptation message comprises determining a recommended number of segments per picture to be sent by the video sender, in which case the adaptation message comprises the recommended number of segments per picture.

Optionally, the generating the adaptation message comprises determining a recommendation of whether to increase or decrease the number of segments per picture to be sent by the video sender, in which case the adaptation message comprises an indication to increase or decrease the number of segments per picture.

The video receiver 5 may comprise a service that is highly reliant on low-latency video such as augmented reality (AR) or other XR-based services, cloud gaming or remote controlling of e.g., drones and industry robots.

The adaptation message may indicate a recommended number of segments, or a recommended segment size for the segments in one or more pictures, where the segment size may be measured in bits or as a spatial resolution, in terms of e.g. pixels or coding blocks. The information may also indicate a recommendation to increase/decrease the number of segments per picture or the segment size. The recommended number of segments may indicate a maximum or minimum number of recommended segments. Likewise, the recommended segment size may indicate a maximum or minimum recommended segment size. A segment may be one of a slice, tile, subpicture, decoding unit, GDR area, and VCL NAL unit.

The information in the adaptation message may be deduced from network condition metrics, e.g., based on queue build-up, channel conditions, interference situation, load conditions are measured and tracked, and/or RAN internal information on configuration such as used numerology, TDD pattern and feature set.

Information may also be received describing a proportion of congestion marked packets, indicating how to adapt the segment size, e.g. increasing or decreasing the segment size. The proportion of congestion marked packets may be determined at the receiver end and fed back to the video sending entity. A congestion marked packet may e.g. be indicated using the ECN bits as part of a (IPv6 or IPv4) header of an IP packet. Any network node between the sender and receiver may mark packets as congested as a response to buffer build up at that node.

Signalling from the video receiver 5 to the network condition evaluator 3 about the minimum segment size or maximum frequency of the segment to assist state switching decision in network may be used to adapt segment size and frequency with the same target data rate or to adapt application data rate. When minimum segment size or maximum frequency of segments is not reached, the network condition evaluator 3 could toggle increasing the number of segments per picture; but when minimum segment size or maximum frequency of segments are reached, and there is queued data in the buffer, the network condition evaluator 3 could trigger the recommendation and send signal to application to reduce application data rate via L4S ECN toggling or ANBRQ signal.

Optionally, the generating the adaptation message comprises reducing the recommended number of segments per picture when network conditions have improved and increasing the recommended number of segments per picture when network conditions have deteriorated.

Optionally, the generating an adaptation message comprises determining the recommended number of segments based on a proportion of congestion marked packets. The congestion marked packet can e.g. be detected using an Explicit Congestion Notification of a header of an IP packet evaluated by the network condition evaluator 1.

Optionally, the adaptation message comprises a proportion of congestion marked packets of all packets detected between the video sender and the video receiver, enabling the video sender to adapt its segmentation based on this proportion.

Optionally, the adaptation message comprises a minimum segment size that can be reliably delivered within a set packet delay budget. The minimum segment size can be determined based on at least one of: time-division duplex pattern, signal strength measurements, interference measurements, power headroom measurements, and queue time.

Optionally, the adaptation message comprises an indication of the maximum segment size, wherein the adaptation message is determining with the maximum segment size for segments of pictures to be sent by the video sender.

Optionally, the adaptation message comprises a recommendation for reducing the number of segments per picture or for increasing the number of segments per picture.

In a send adaptation message step 54, the network condition evaluator 3 sends the adaptation message 30 to the video sender 2. The adaptation message 30 can be signalled through an API exposed at application layer or signalled in a similar way as L4S, that involves toggling of a bit in a communication frame header with increasing or decreasing frequency to indicate the need for a less or more granular source sensor representation.

In a receive adaptation message step 40, the video sender 2 receives the adaptation message 30 from the network condition evaluator 3 of the communication network 9. As explained above, the adaptation message 30 is based on network conditions on a path of the communication network 9 between the video sender 2 and a video receiver 5.

The adaptation message 30 can comprise an indication of a maximum segment size. The adaptation message 30 can comprise a recommended number of segments per picture. The adaptation message 30 can comprise a recommendation for reducing the number of segments per picture or a recommendation for increasing the number of segments per picture.

In an adapt step 42, the video sender 2 adapts the number of segments of at least one future picture. The adapting the number of segments is performed based on the adaptation message.

When the adaptation message comprises the maximum segment size, the adapting the number of segments is performed under the condition of complying with the indication of the maximum segment size.

When the adaptation message comprises the recommended number of segments per picture, the adapting the number of segments comprises adapting the number of segments to the recommended number of segments per picture.

The video sender 2 can comprise a video encoder 21, in which case the adapting the number of segments of the one or more pictures, can be performed by the video encoder.

In one embodiment, a first value in the adaptation message triggers the encoder to encode one segment per picture and a second value in the adaptation message triggers the encoder to encode multiple segments per picture. In one version, the number of multiple segments is a predetermined fixed number.

Each one of the segments can be at least one of a slice, tile, subpicture, decoding unit, gradual decoding refresh area, and video coding layer network abstraction layer unit, as exemplified above.

The adapting the number of segments can be performed such that improved network conditions result in fewer segments per picture 10 and deteriorated network conditions result in more segments per picture 10.

In a send segments step 44, the video sender 2 sends the segments 32 of the at least one future picture to the video receiver 5, suitably packetized and provided in a video bitstream. The sending can comprise sending each one of the segments individually.

In a receive segments step 58, the video receiver 5 receives the video bitstream from the video sender 2 (via the communication network 9) and extracts the segments. This allows the video receiver 5 to reconstruct the video picture(s) and render the video for a user (or machine) to see.

Hence, the video receiver 5 decodes the coded segments in the received video bitstream one-by-one and forwards the decoded segments one-by-one for further processing to a processing entity, e.g. a SLAM or object detection algorithm, which processes the picture before receiving all decoded segments of the picture. For parts of the picture that has not been received for the current picture, data from a previous picture may be used.

Using embodiments presented herein, the usage coverage for time-critical high bitrate services, such as augmented reality or SLAM, is extended, allowing the video bitstream to be provided within a delay budget without reducing video encoding bitrate.

With the proposed solution, the video sender 2 can adjust segmentation dynamically. As long as the RAN has enough capacity to offer a big TBS (transport block size) that can often carry a whole picture, the video sender 2 can avoid segmenting the picture. In this case, the video sender 2 can keep the data bandwidth usage optimal, because without segmentation, the video compression efficiency is the best due to low overhead. In addition, avoiding segmentation may have benefits in terms of power saving, since larger chunks transmitted more seldomly makes it more likely that a DRX (discontinuous reception) pattern (that enables the radio base station and/or UE to go into micro-sleep mode) can be applied. In periods when the RAN can only offer a limited TBS size, segmentation provides a means to keep the latency requirements in the RAN, at the expense of slightly increased data bandwidth requirements caused by a less efficient compression method and/or increased power consumption at the device/radio base station. Hence, embodiments presented herein allow the video sender 2 to use the RAN also in situations with worse network conditions.

In contrast, congestion control solutions in the art respond with gradual quality degradation to deteriorating network conditions. The embodiments presented herein allow a complementary way to respond to deteriorating network conditions without quality degradations, whereby this method is preferable as a first response to deteriorating network conditions.

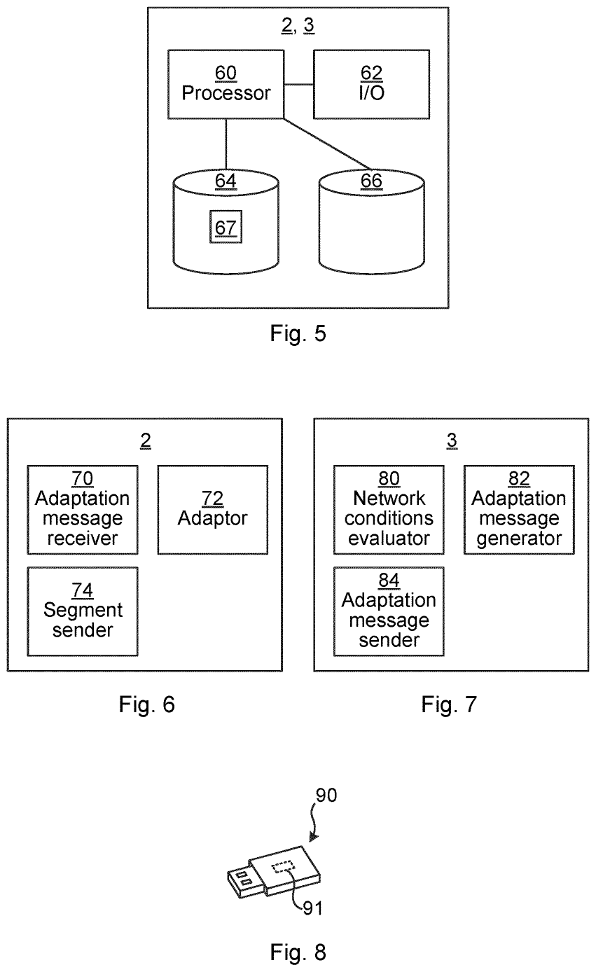

FIG. 5 is a schematic diagram illustrating components of the video sender 2 and/or the network condition evaluator 3 of FIG. 1. It is to be noted that when the network condition evaluator 3 is implemented in a host device, one or more of the mentioned components can be shared with the host device. A processor 60 is provided using any combination of one or more of a suitable central processing unit (CPU), graphics processing unit (GPU), multiprocessor, neural processing unit (NPU), microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the methods described with reference to FIG. 4 above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

An I/O interface 62 is provided for communicating with external and/or internal entities using wired communication, e.g. based on Ethernet, and/or wireless communication, e.g. Wi-Fi, and/or a cellular network, complying with any one or a combination of sixth generation (6G) mobile networks, next generation mobile networks (fifth generation, 5G), LTE (Long Term Evolution), UMTS (Universal Mobile Telecommunications System) utilising W-CDMA (Wideband Code Division Multiplex), or any other current or future wireless network, as long as the principles described hereinafter are applicable.

Other components are omitted in order not to obscure the concepts presented herein.

FIG. 6 is a schematic diagram showing functional modules of the video sender 2 of FIG. 1 according to one embodiment. The modules are implemented using software instructions such as a computer program executing in the video sender 2. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods for the video sender 2 illustrated in FIG. 4.

An adaptation message receiver 70 corresponds to step 40. An adaptor 72 corresponds to step 42. A segment sender 74 corresponds to step 44.

FIG. 7 is a schematic diagram showing functional modules of the network condition evaluator 3 of FIG. 3A or 3B according to one embodiment. The modules are implemented using software instructions such as a computer program executing in the network condition evaluator 3. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods for the network condition evaluator 3 illustrated in FIG. 4.

A network condition evaluator 80 corresponds to step 50. An adaptation message generator 82 corresponds to step 52. An adaptation message sender 84 corresponds to step 54.

FIG. 8 shows one example of a computer program product 90 comprising computer readable means. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 5. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1-40. (canceled)

41. A method performed by a video sender connected to a communication network, the method comprising:
receiving an adaptation message from a network condition evaluator of the communication network, wherein the adaptation message is based on network conditions on a path of the communication network between the video sender and a video receiver;
adapting a number of segments of a picture based upon an indication in the adaptation message; and
sending the segments of the picture to the video receiver, wherein
the adaptation message comprises:
an indication of a maximum segment size;
an indication of a recommended number of segments per picture; and/or
an indication of a recommendation for reducing the number of segments per picture or a recommendation for increasing the number of segments per picture.

42. The method of claim 41, wherein adapting the number of segments is performed under a condition of complying with the indication of a maximum segment size.

43. The method of claim 41, wherein adapting the number of segments comprises adapting the number of segments to the indication of the recommended number of segments per picture.

44. The method of claim 41, wherein each one of the segments is a slice, a tile, a subpicture, a decoding unit, a gradual decoding refresh area, and a video coding layer network abstraction layer unit.

45. A video sender, the video sender being configured to be connected to a communication network, the video sender comprising:
a receiver for receiving an adaptation message from a network condition evaluator of the communication network, wherein the adaptation message is based on network conditions on a path of the communication network between the video sender and a video receiver;
a processor; and
a memory storing instructions that, when executed by the processor, cause the video sender to:
adapt a number of segments of a picture based upon an indication in the adaptation message; and
send the segments of the picture to the video receiver, wherein
the adaptation message comprises:
an indication of a maximum segment size;
an indication of a recommended number of segments per picture; and/or
an indication of a recommendation for reducing the number of segments per picture or a recommendation for increasing the number of segments per picture.

46. The video sender of claim 45, wherein the instructions to adapt the number of segments comprise instructions that, when executed by the processor, cause the video sender to adapt under the condition of complying with the indication of a maximum segment size.

47. The video sender of claim 45, wherein the instructions to adapt the number of segments comprise instructions that, when executed by the processor, cause the video sender to adapt the number of segments to the indication of a recommended number of segments per picture.

48. The video sender of claim 45, wherein each one of the segments is at least one of a slice, tile, subpicture, decoding unit, gradual decoding refresh area, and video coding layer network abstraction layer unit.

49. A computer program product comprising a computer readable means comprising non-transitory memory in which a computer program is stored, the computer program comprising computer program code which, when executed on a video sender causes the video sender to perform the method of claim 41.

50. A method for controlling the sending of at least one picture, the method being performed in a network condition evaluator connected to a communication network, the method comprising:
evaluating network conditions of at least part of a path of the communication network between a video sender and a video receiver;
generating an adaptation message based on the network conditions, wherein the adaptation message comprises an indication for the video sender to adapt the number of segments in at least one future picture; and
sending the adaptation message to the video sender, wherein
the adaptation message comprises:
an indication of a recommended number of segments per picture;
an indication of a recommended number of segments per picture when network conditions have deteriorated; and/or
an indication of a recommendation for reducing the number of segments per picture or a recommendation for increasing the number of segments per picture.

51. The method of claim 50, wherein the generating an adaptation message comprises determining the recommended number of segments based on a proportion of congestion marked packets.

52. The method of claim 51, wherein a congestion marked packet is detected using an Explicit Congestion Notification of a header of an internet protocol packet evaluated by the network condition evaluator.

53. The method of claim 51, wherein the adaptation message comprises a proportion of congestion marked packets of all packets detected between the video sender and the video receiver.

54. The method of claim 50, wherein the generating an adaptation message comprises determining a minimum segment size that can be reliably delivered within a set packet delay budget.

55. The method of claim 54, wherein the determining a minimum segment size is made based on at least one of: time-division duplex pattern, signal strength measurements, interference measurements, power headroom measurements, and queue time.

56. The method of claim 50, wherein the generating an adaptation message comprises determining a maximum segment size for segments of pictures to be sent by the video sender, wherein the adaptation message comprises an indication of the maximum segment size.

57. The method of claim 50, wherein the evaluating network conditions is based on metrics of the communication network for at least one of: queue build-up, channel conditions, interference situation, load conditions, power headroom indications, numerology, and Time Division Duplex pattern.

58. The method of claim 50, wherein the network condition evaluator is a radio base station, a router, a gateway, or the video receiver.

59. A network condition evaluator for controlling the sending of at least one picture, the network condition evaluator being configured to be connected to a communication network, the network condition evaluator comprising:
a processor; and
a memory storing instructions that, when executed by the processor, cause the network condition evaluator to:
evaluate network conditions of at least part of a path of the communication network between a video sender and a video receiver;
generate an adaptation message based on the network conditions, wherein the adaptation message comprises an indication for the video sender to adapt the number of segments in at least one future picture; and
send the adaptation message to the video sender, wherein
the adaptation message comprises:
an indication of a maximum segment size;
an indication of a recommended number of segments per picture; and/or
an indication of a recommendation for reducing the number of segments per picture or a recommendation for increasing the number of segments per picture.

60. The network condition evaluator of claim 59, wherein the network condition evaluator is a radio base station, a router, a gateway, or the video receiver.

61. A computer program product comprising a computer readable means comprising non-transitory memory in which a computer program is stored, the computer program comprising computer program code which, when executed on a network condition evaluator configured to be connected to a communication network, causes the network condition evaluator to perform the method of claim 59.
